(19) United States
(12) Patent Application Publication
(10) Pub. No.: US 2005/0257854 A1
(43) Pub. Date: Nov. 24, 2005

(54) Manufacturing method for a soft magnetic material, a soft magnetic material, a manufacturing method for a powder metallurgy soft magnetic material, and a powder metallurgy soft magnetic material

(75) Inventors: Toru Maeda, Itami-shi (JP); Naoto Igarashi, Itami-shi (JP); Haruhisa Toyoda, Itami-shi (JP); Koji Mimura, Itami-shi (JP)

Correspondence Address: DARBY & DARBY P.C., P. O. BOX 5257, NEW YORK, NY, 10150-5257, US

(73) Assignee: Sumitomo Electric Industries, Ltd., Osaka-shi (JP)

(21) Appl. No.: 11/127,970

(22) Filed: May 11, 2005

(30) Foreign Application Priority Data
May 24, 2004 (JP) 2004-153455

(51) Int. Cl. H01F 1/22

(52) U.S. Cl. 148/104; 148/105

(57) ABSTRACT

The object of the present invention is to provide a method for manufacturing a soft magnetic material, a soft magnetic material, a method for manufacturing a P/M soft magnetic material, and a P/M soft magnetic material which achieve the desired magnetic properties.

In the method for manufacturing the soft magnetic material of the present invention, there is a first heat treatment step (step S3) in which a metal magnetic particle 10, which has iron as its main component, is heat treated to a temperature of 900 degrees C. or greater and less than the melting point of metal magnetic particle 10. After the first heat treatment step (step S3), there is a step for forming a plurality of composite magnetic particles 30 which are metal magnetic particles 10 surrounded by an insulation covering 20 (step S6).

### BACKGROUND OF THE INVENTION

1. Field of the Invention

The present invention relates to a manufacturing method for a soft magnetic material, a soft magnetic material, a manufacturing method for a powder metallurgy (P/M) soft magnetic material, and a P/M soft magnetic material. More specifically, the present invention relates to a manufacturing method for a soft magnetic material, a soft magnetic material, a manufacturing method for a P/M soft magnetic material, and a P/M soft magnetic material which use a composite magnetic particle constructed from a metal magnetic particle and an insulating covering which surrounds this metal magnetic particle.

2. Description of the Background Art

In the prior art, with electronic components such as cores of motors and cores of transformers and the like, there have been attempts to increase density and decrease size, and there is a desire for a more precise control using less power. Because of this, there have been advances in the development of soft magnetic material for use in the creation of these electronic parts, in particular soft magnetic material which possess excellent magnetic properties in the middle high frequency range.

With this kind of soft magnetic material, in Japanese Laid-Open Patent Number 2002-246219, there is disclosed a dust core and a manufacturing method for the same in which the object of the invention is to maintain its magnetic properties even when using under high temperature environments. With the method for manufacturing a dust core disclosed in Japanese Laid-Open Patent Publication Number 2002-246219, first, phosphate-coated, atomized iron powder is mixed with a prescribed amount of polyphenylene sulfide (PPS resin). This is compressed and molded. The resulting molded body is heated for one hour in air at a temperature of 320 degrees C. This is further heated for 1 hour at a temperature of 240 degrees C. Afterwards, this is cooled to create the dust core.

In the interior of the dust core created in this manner, if there are numerous distortions (point defects, dislocations, crystal grain boundaries), these distortions interfere with the magnetic domain wall displacement (magnetic flux changes) and causes reduced magnetic permeability of the dust core. With the dust core disclosed in Japanese Laid-Open Patent Publication Number 2002-246219, the heat treatment implemented on the molded body over two times is not sufficient for eliminating the distortions present in the interior. As a result, the effective magnetic permeability of the resulting dust core is at a low value of 400 or less, with some variation due to frequency and the PPS resin content.

Furthermore, in order to adequately reduce the distortions present in the interior of the dust core, the temperature of heat treatment could be raised. However, because the phosphate compound coating the atomized iron powder has poor heat resistance, it can deteriorate if the temperature during heat treatment is set too high. Because of this, the eddy current loss between particles of phosphate-coated atomized iron powder is increased, and there may be reduced magnetic permeability of the dust core.

### SUMMARY OF THE INVENTION

The object of the present invention is to solve the above problems. The object of the invention is to provide a manufacturing method for a soft magnetic material, a soft magnetic material, a manufacturing method for a P/M soft magnetic material, and a P/M soft magnetic material which can achieve the desired magnetic properties.

The method for manufacturing a soft magnetic material of the present invention comprises a first heat treatment step in which a metal magnetic particle having a main component of iron is treated with heat to a temperature of 900 degrees C. or greater but less than the melting point of the metal magnetic particle, and after the first heat treatment step, a step for forming a plurality of composite magnetic particles in which metal magnetic particles are surrounded by an insulating covering.

According to the manufacturing method for a soft magnetic material of the present invention, by the first heat treatment of the metal magnetic particle, the distortions present internally in the metal magnetic particle are reduced. For this, the temperature of heat treatment is 900 degrees C. or greater. As a result, the crystals of the metal magnetic particles are recrystallized by the heat treatment. With this, point defects and dislocations which are present within the metal magnetic particle are reduced. As a result, the dislocations within the metal magnetic particle are reduced greatly. In addition, because the temperature of the heat treatment is less than the melting point of the metal magnetic particle, heat treatment is conducted without melting the metal magnetic particle. Therefore, the magnetic permeability of the soft magnetic material increases, and the coercive force is reduced, and the desired magnetic properties are achieved. In addition, because the step for forming a plurality of composite magnetic particles is conducted after the first heat treatment, the insulation coating is not affected by the heat of the first heat treatment.

In the manufacturing method for a soft magnetic material of the present invention, preferably, after the first heat treatment step, there is also a second heat treatment step in which the metal magnetic particle is heated to a temperature of 400 degrees C. or greater and less than 900 degrees C. The step for forming the plurality of composite magnetic particles is conducted after the second heat treatment step.

With this method, if distortions such as point defects and dislocations reappear when lowering the temperature to room temperature after the first heat treatment step, there is a second heat treatment step to reduce these distortions. In addition, because the formation of plurality of composite magnetic particles is conducted after the second heat treatment step, the insulation covering is not affected by the heat of the second heat treatment step.

The soft magnetic material of the present invention preferably has a step in which metal magnetic particles are mixed with spacer particles prior to the first heat treatment step.

With this method, the metal magnetic particles exist with spacer particles in between them. As a result, the metal magnetic particles are separated from each other in the first heat treatment step. As a result, the metal magnetic particles are prevented from being sintered and clumped together. Therefore, there is no need for mechanically breaking up clumped metal magnetic particles after the first heat treatment step. When metal magnetic particles are mechanically broken up, new distortions can arise in the interior of the metal magnetic particles, and this problem can be avoided.

In the manufacturing method for the soft magnetic material of the present invention, the ratio (D2/D1) of the average particle size D1 of the metal magnetic particle to the average particle size D2 of the spacer particle is preferably 0.1≦(D2/D1)≦2.

If (D2/D1) is 0.1 or greater, the distance between metal magnetic particles is sufficient. In addition, spacer particles are less likely to become trapped into the rough surface of the metal magnetic particle surface. In addition, by having the ratio D2/D1 less than 2, the clumping of metal magnetic particles between spacer particles is prevented. From the above, there is improved separation of the metal magnetic particles from each other.

For the manufacturing method of the soft magnetic material of the present invention, the spacer particle is preferably an oxide, nitride, or carbide of at least one element selected from the group consisting of Al (aluminum), Si (silicon), Y (yttrium), Zr (zirconium), Ti (titanium), Mg (magnesium), and B (boron).

These materials have high melting points, and as a result, they do not melt at all during the first heat treatment step. In addition, these materials are chemically stable. Therefore, these materials are well-suited for spacer particles.

For the manufacturing method of the soft magnetic material of the present invention, the first heat treatment step is conducted while moving the metal magnetic particles.

This prevents the same metal magnetic particles from being in continuous contact with each other during the first heat treatment step. As a result, the sintering and clumping of metal magnetic particles is prevented. Therefore, there is no need for mechanically breaking up clumped metal magnetic particles after the first heat treatment step. When metal magnetic particles are mechanically broken up, new distortions can arise in the interior of the metal magnetic particles, and this problem can be avoided with this method.

The soft magnetic material of the present invention is manufactured by the manufacturing method described above.

The method for manufacturing a P/M soft magnetic material of the present invention comprises a pressure molding step for pressure molding the soft magnetic material manufactured by the manufacturing method described above.

With this method, there is increased magnetic permeability and reduced coercive force of the P/M soft magnetic material, and the desired magnetic properties are achieved.

In the method for manufacturing a P/M soft magnetic material of the present invention, the pressure molding step includes a step for forming a P/M soft magnetic material in which a plurality of composite magnetic particles are joined together by an organic substance.

With this method, an organic substance is present between each of the plurality of composite magnetic particles. The organic substance acts as a lubricating agent during pressure molding. As a result, damage to the insulation covering is suppressed during pressure molding.

In the method for manufacturing a P/M soft magnetic material of the present invention, there is a further third heat treatment step in which after the pressure molding step, the P/M soft magnetic material is heat treated to a temperature greater than 30 degrees C. and less than the heat decomposition temperature of the insulation covering.

With this method, distortions generated during the pressure molding step is reduced. Because the distortions present in the interior of metal magnetic particles are reduced in the first heat treatment step, the distortions present in the P/M soft magnetic material is primarily generated by pressurization during pressure molding. Therefore, the distortions present in the interior of the P/M soft magnetic material are present without being complexly entangled with each other. For these reasons, even with a relatively low temperature of less than the heat decomposition temperature of the insulation covering, for example with a phosphate type insulation covering this is 500 degrees C. or less, distortions in the interior of the molded body are effectively reduced. In addition, because the temperature of heat treatment is less than the thermal decomposition temperature of the insulation covering, the insulation covering surrounding the metal magnetic particles does not deteriorate. As a result, the eddy current loss between particles is effectively suppressed. In addition, an adequate effect is achieved in the third heat treatment step by having a heat treatment temperature of 30 degrees C. or greater.

The P/M soft magnetic material of the present invention is manufactured by the method described above.

In the present specification, “a metal magnetic particle having a main component of iron” is a metal magnetic particle which contains iron at a ratio of 50% by mass or greater.

As described above, with the manufacturing method for a soft magnetic material, soft magnetic material, manufacturing method for a P/M soft magnetic material, and P/M soft magnetic material of the present invention, the desired magnetic properties are achieved.

### BRIEF DESCRIPTION OF THE DRAWINGS

FIG. 1 is a diagram showing an enlargement of a P/M soft magnetic material of implementation mode 1 of the present invention.

FIG. 2 is a process diagram showing the method for manufacturing the P/M soft magnetic material of implementation mode 1 of the present invention.

FIG. 3 is a cross-sectional diagram showing the first heat treatment step of implementation mode 1 of the present invention.

FIG. 4 is a process diagram showing the method for manufacturing the P/M soft magnetic material of implementation mode 2 of the present invention.

FIG. 5 is a cross-sectional diagram showing the first heat treatment step of implementation mode 2 of the present invention.

### DETAILED DESCRIPTION OF THE INVENTION

Referring to the figures, the embodiments of the present invention are described.

(Implementation Mode 1)

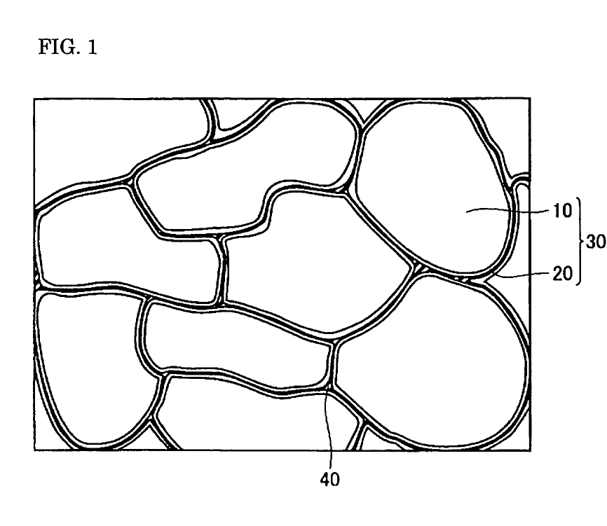

FIG. 1 is a drawing showing an enlarged P/M soft magnetic material of Implementation mode 1 of the present invention.

Referring to FIG. 1, the P/M soft magnetic material of the present mode is constructed from a plurality of composite magnetic particles 30 and an organic substance 40 which is present between each of the plurality of composite magnetic particles 30. Each of the plurality of composite magnetic particles 30 has a metal magnetic particle 10 and an insulation covering 20, which surrounds the surface of metal magnetic particle 10. Each of the plurality of the composite magnetic particles 30 is joined together by organic substance 40 or is joined together by the enmeshing of the irregular surfaces of composite magnetic particles 30.

Next, the method for manufacturing the P/M soft magnetic material of the present mode will be described.

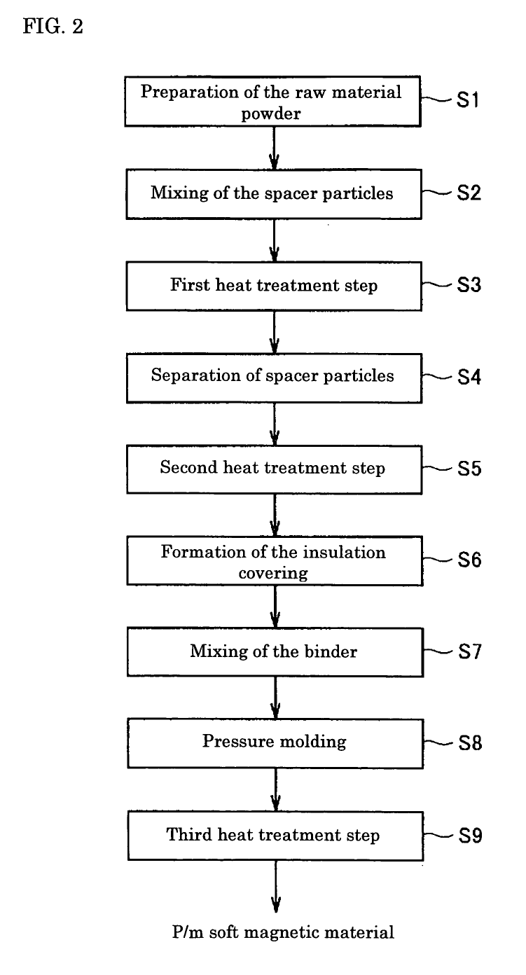

FIG. 2 is a process diagram showing the method for manufacturing the P/M soft magnetic material of Implementation mode 1.

Referring to FIG. 2, first, the raw material powder for metal magnetic particle 10 is prepared (Step S1). Metal magnetic particle 10 has Fe (iron) as its main component and, for example, is formed from pure iron, Fe—Si alloy, Fe—N (nitrogen) alloy, Fe—Ni (nickel) alloy, Fe—C (carbon) alloy, Fe—B alloy, Fe—Co (cobalt) alloy, Fe—P (phosphorus) alloy, Fe—Ni—Co alloy, and Fe—Al—Si alloy, and the like. Metal magnetic particle 10 can be a metal simple substance or an alloy.

The average particle diameter D1 for metal magnetic particle 10 is preferably 5 micrometers or greater and 300 micrometers or less. When average particle diameter D1 for metal magnetic particle 10 is 5 micrometers or greater, the metal is not as readily oxidized, and as a result, the magnetic properties of the soft magnetic material are improved. In addition, when the average particle diameter D1 for metal magnetic particle 10 is 300 micrometers or less, the compressibility of the mixed powder is not reduced during the pressure molding which is described later. As a result, the molded body obtained by pressure molding has a greater density.

The average diameter size is the 50% diameter size D. In other words, in a histogram of particle diameters as measured by the sieve method, the particle diameter at which the sum of the masses from the smaller diameters reaches 50% of the total mass is the average diameter.

The particle diameters for metal magnetic particles 10 are preferably distributed only within the range of 38 micrometers or greater and less than 355 micrometers. Particles having a particle diameter of less than 38 micrometers or a particle size of 355 micrometers or greater are eliminated, and the remaining particles are used as metal magnetic particles 10. Even more preferably, metal magnetic particles 10 are distributed only within a range of 75 micrometers or greater and less than 355 micrometers.

Next, spacer particles are mixed with metal magnetic particles 10 (Step S2). For the spacer particles, an oxide, nitride, or carbide of at least one element selected from the group consisting of Al, Si, Y, Zr, Ti, Mg, and B is suitable, however other materials can also be used. In addition, the ratio (D2/D1) of the average particle size D1 of the metal magnetic particle to the average particle size of the spacer particle D2 is preferably 0. 1≦(D2/D 1)≦2. The spacer particles are preferably mixed in an amount at which the volume of metal magnetic particles 10 is less than a volume ratio between magnetic particles 10 and spacer particles of 2:1.

Next, metal magnetic particles 10 mixed with spacer particles are heated in an hydrogen atmosphere or argon atmosphere for 1 hour at a temperature that is 900 degrees C. or greater and less than the melting point of metal magnetic particle 10 (Step S3). This heat treatment is preferably conducted at a temperature that is 50 degrees C. or more lower than the melting point of metal magnetic particles 10. If metal magnetic particles 10 are of pure iron, the heat treatment is preferably conducted at 1450 degrees C. or less.

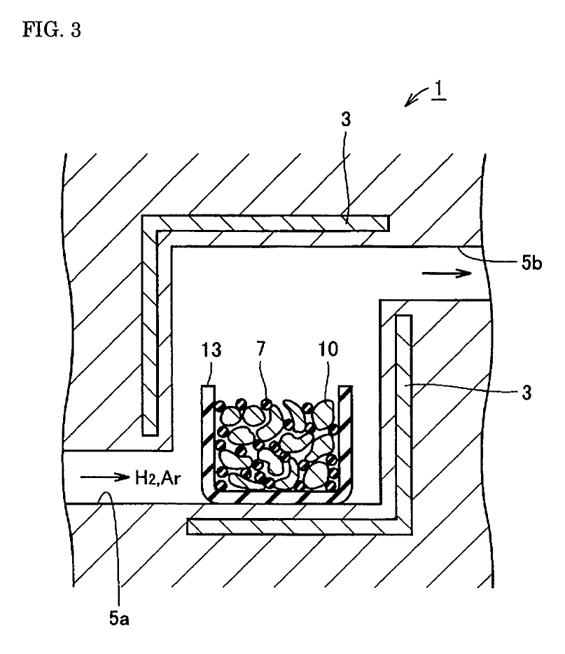

FIG. 3 is a cross-section showing the first heat treatment step of implementation mode 1 of the present invention. Referring to FIG. 3, a container 13 filled with metal magnetic particles 10 and spacer particles 7 is placed inside an electric furnace 1, which has an internal heater 3. There is a gas inlet opening 5a and a gas exhaust opening 5b formed on electric furnace 1. For example, hydrogen gas or argon gas or the like flows from gas inlet opening 5a to gas exhaust opening 5b.

By mixing spacer particles 7 with metal magnetic particles 10, there are spacer particles 7 between metal magnetic particles 10. As a result, metal magnetic particles 10 are separated from each other during heat treatment. Because of this, even when heating to a temperature greater than 900 degrees C., the metal magnetic particles 10 are not readily sintered.

Prior to heat treatment, there are many distortions (dislocations, point defects, crystal grain boundaries) present in the interior of metal magnetic particle 10. In the present mode, by having a heat treatment temperature of 900 degrees C. or greater, the crystals in metal magnetic particles 10 are recrystallized. As a result, point defects and dislocations present inside metal magnetic particles 10 are reduced. In addition, crystal grain boundaries are also reduced.

Next, only spacer particles 7 are separated from the mixture of metal magnetic particles 10 and spacer particles 7 (Step S4). If spacer particles 7 are of non-magnetic material, the separation of spacer particles 7 is conducted by a method of attracting metal magnetic particles 10 by bringing a magnet close to the mixture of metal magnetic particles 10 and spacers 7.

Next, metal magnetic particles 10 are heated in an hydrogen atmosphere, for example, for 1 hour at a temperature that is 400 degrees C. or greater and less than 900 degrees C. (second heat treatment step, Step S5). After completing the first heat treatment step (Step S3), when lowering the temperature to room temperature, depending on the cooling conditions, there may be residual heat distortions in the crystals of metal magnetic particles 10. Particularly when metal magnetic particles 10 are of pure iron, the crystals of metal magnetic particles 10 have phase transformations from the gamma phase to the alpha phase, and as a result, there is a large heat distortion. By heating again to a temperature that is 400 degrees C. or greater and less than 900 degrees C., the point defects and dislocations present inside metal magnetic particles 10 are reduced. Second heat treatment step (step S5) is not a required step and may be omitted.

Next, by forming insulation covering 20 on the surface of metal magnetic particle 10, a plurality of composite magnetic particles 30, which are metal magnetic particles 10 surrounded by insulation covering 20, are created (Step S6). Insulation covering 20 can be formed by phosphatization treatment of metal magnetic particles 10. Through phosphatization treatment, insulation covering 20 of iron phosphate, which contains phosphorus and iron for example, manganese phosphate, zinc phosphate, calcium phosphate, or aluminum phosphate and the like, is formed.

In addition, an insulation covering 20 containing an oxide can also be formed. For the insulation covering 20 containing an oxide, oxide insulators such as silicon oxide, titanium oxide, aluminum oxide, or zirconium oxide, and the like can be used.

Insulation covering 20 functions as an insulation layer between metal magnetic particles 10. By surrounding metal magnetic particles 10 with insulation covering 20, the electrical resistivity rho is increased. With this, flow of eddy currents between metal magnetic particles 10 is suppressed, and iron loss of soft magnetic material which is caused by eddy currents is reduced.

The thickness of insulation covering 20 is preferably 0.005 micrometers or greater and 20 micrometers or less. By having an insulation coating 20 of thickness 0.05 micrometers or greater, energy loss by eddy currents is effectively suppressed. In addition, by having an insulation covering 20 of thickness 20 micrometers or less, the proportion of insulation covering 20 within the soft magnetic material is not too large. As a result, dramatic reductions in the magnetic flux density of the soft magnetic material are prevented.

From the steps described above, the soft magnetic material of the present implementation mode is completed. By completing the following manufacturing steps, the P/M soft magnetic material of the present implementation mode is manufactured.

Next, a mixture powder is obtained by mixing composite magnetic particles 30 with organic substance 40 which is a binder (Step S7). There are no limitations on the mixing method. For example, a mechanical alloying method, a vibration ball mill, an epicyclic ball mill, mechanofusion, coprecipitation method, chemical vapor deposition method (CVD method), physical vapor deposition method (PVD method), plating method, sputtering method, vapor deposition method or sol-gel method, and the like can be used. With this, each of the plurality of composite magnetic particles 30 is joined together by organic substance 40.

For organic substance 40, thermoplastic resins such as thermoplastic polyimide, thermoplastic polyamide, thermoplastic polyamide imide, polyphenylene sulfide, polyamide imide, polyether sulfone, polyether imide, or polyether ether ketone, and the like, non-thermoplastic resins such as high molecular weight polyethylene, all aromatic polyesters or all aromatic polyimides, and the like, higher fatty acids such as zinc stearate, lithium stearate, calcium stearate, lithium palmitate, calcium palmitate, lithium oleate, and calcium oleate, and the like can be used. In addition, these can be mixed with each other and used.

The proportion of organic substance 40 with respect to the soft magnetic material is preferably above 0 and is 1.0% by mass or less. By having a proportion of organic substance 40 of 1.0% by mass or less, the proportion of metal magnetic particles 10 in the soft magnetic material is maintained at a constant or greater. With this, a soft magnetic material with a higher magnetic flux density is achieved. The mixing of organic substance 40 (step S7) is not a required step. Pressure molding can be implemented with only composite magnetic particles 30 without mixing organic substance 40.

Next, the resulting mixture powder is placed in a die, and this is pressure molded with a pressure ranging from 700 MPa to 1500 MPa, for example (Step S8). With this, the mixture powder is compressed, and a molded body is obtained. The atmosphere during pressure molding is preferably an inert gas atmosphere or reduced pressure atmosphere. In this situation, the oxidation of the mixture powder by the oxygen in the atmosphere is suppressed.

During pressure molding, organic substance 40 acts as a buffering material between composite magnetic particles 30. As a result, damage to insulation covering 20 resulting from contact of composite magnetic particles 30 with each other is prevented.

Next, the molded body obtained by pressure molding is heat treated at a temperature of 30 degrees C. or greater and less than the heat decomposition temperature of insulation covering 20 (third heat treatment step, Step S9). For example, the heat decomposition temperature for insulation covering 20 is 500 degrees C. for a phosphate-type insulation covering. This heat treatment is implemented mainly in order to reduce distortions generated in the interior of the molded body during pressure molding. In order to reduce distortions generated in the molded body during pressure molding, heat treatment is at a temperature of preferably 200 degrees C. or greater and the temperature of thermal decomposition of insulation covering 20 or less.

Distortions originally present in the interior of metal magnetic particles 10 have already been removed by implementation of heat treatments of metal magnetic particles 10 (Step S3, Step S5). As a result, the amount of distortions present in the interior of the molded body after pressure molding is relatively small. In addition, distortions generated during pressure molding do not have complex entanglements with distortions originally present in the interior of metal magnetic particles 10. Furthermore, the new distortions are generated by a unidirectional pressure on the mixture powder housed in the die. For these reasons, even though heat treatment is conducted at a relatively low temperature of less than the heat decomposition temperature of insulation covering 20, the distortions present in the interior of the molded body is easily reduced.

In addition, because there is hardly. any distortions present in the interior of metal magnetic particle 10, composite magnetic particle 30 is easily deformed during pressure molding. As a result, as shown in FIG. 1, the molded body is formed with the plurality of composite magnetic particles 30 enmeshed with each other with no space in between them. With this, the molded body has an increased density, and a high magnetic permeability is achieved.

In addition, because the heat treatment of the molded body is implemented at a relatively low temperature, insulation covering 20 does not deteriorate. With this, even after heat treatment, insulation covering 20 is still covering metal magnetic particle 10, and flow of eddy currents between metal magnetic particles 10 is prevented by insulation covering 20. More preferably, the molded body obtained by pressure molding is heat treated at a temperature between 200 degrees and 300 degrees. With this, the deterioration of insulation covering 20 is further suppressed. The third heat treatment step (Step S9) is not required and can be omitted.

With the processes described above, the P/M soft magnetic material of the present implementation mode is completed.

The manufacturing method for the soft magnetic material of the present implementation mode comprises: a first heat treatment step (Step S3) for heat treating of metal magnetic particle 10, which has iron as its main component, to a temperature that is 900 degrees C. or greater and less than the melting point of metal magnetic particle 10; and after the first heat treatment step (Step S3), a step for forming a plurality of composite magnetic particles 30 in which metal magnetic particles 10 are surrounded by insulation covering 20 (Step S6).

According to the manufacturing method for the soft magnetic material of the present implementation mode, by conducting a first heat treatment step (Step S3) on metal magnetic particle 10, the distortions present in the interior of metal magnetic particle 10 are reduced. Because the temperature of heat treatment is 900 degrees C. or greater, the crystals of metal magnetic particle 10 are recrystallized by heat treatment. With this, point defects and dislocations which are present within the metal magnetic particle are reduced. In addition, crystal grain boundaries present within metal magnetic particles 10 are also reduced. As a result, the distortions within the metal magnetic particle are reduced greatly. In addition, because the temperature of the heat treatment is less than the melting point of metal magnetic particle 10, heat treatment is conducted without melting metal magnetic particle 10. Therefore, the magnetic permeability of the soft magnetic material increases, and the coercive force is reduced, and the desired magnetic properties are achieved. In addition, because the step for forming a plurality of composite magnetic particles 30 (Step S6) is conducted after the first heat treatment step (Step S3), insulation coating 20 is not affected by the heat of the first heat treatment (Step S3).

The manufacturing method for the soft magnetic material of the present implementation mode also has a second heat treatment step (Step S5) after the first heat treatment step (Step S3). In the second heat treatment step (Step S5), metal magnetic particle 10 is heated to a temperature of 400 degrees C. or greater and less than 900 degrees C. The step for forming the plurality of composite magnetic particles 30 (Step S6) is conducted after the second heat treatment step (Step S5).

With this, if distortions such as point defects and dislocations reappear inside metal magnetic particle 10 when lowering the temperature to room temperature after the first heat treatment step (Step S3), there is a second heat treatment step (Step S5) to reduce these distortions. In addition, because the step for formation of the plurality of composite magnetic particles 30 (Step S6) is conducted after the second heat treatment step (Step S5), insulation covering 20 is not affected by the heat of the second heat treatment step (Step S5).

The manufacturing method for the soft magnetic material of the present implementation mode also has a step for mixing metal magnetic particles 10 with spacer particles 7 prior to the first heat treatment step (Step S3).

With this, metal magnetic particles 10 exist with spacer particles 7 in between them. As a result, metal magnetic particles 10 are separated from each other during the first heat treatment step (Step S3). As a result, metal magnetic particles 10 are prevented from being sintered and clumped together. Therefore, there is no need for mechanically breaking up clumped metal magnetic particles after the first heat treatment step (Step S3). When metal magnetic particles are mechanically broken up, new distortions can arise in the interior of the metal magnetic particles, but with this step, this problem is avoided.

In the manufacturing method for the soft magnetic material of the present implementation mode, the ratio (D2/D1) of the average particle size D1 of metal magnetic particle 10 to the average particle size D2 of spacer particle 7 is preferably 0.1≦(D2/D 1)≦2.

If (D2/D1) is 0.1 or greater, the distance between metal magnetic particles 10 is sufficient. In addition, spacer particles 7 are less likely to become trapped into the rough surface of metal magnetic particle 10. In addition, by having the ratio D2/D1 less than 2, the clumping of metal magnetic particles 10 between spacer particles 7 is prevented. From the above, there is improved separation of metal magnetic particles 10 from each other.

For the manufacturing method of the soft magnetic material of the present invention, spacer particle 7 is preferably an oxide, nitride, or carbide of at least one element selected from the group consisting of Al, Si, Y, Zr, Ti, Mg, and B.

These materials have high melting points, and as a result, they do not melt during the first heat treatment step (Step S3). In addition, these materials are chemically stable. Therefore, these materials are well-suited for spacer particles 7.

The method for manufacturing a P/M soft magnetic material of the present implementation mode comprises a pressure molding step (Step S8) for pressure molding the soft magnetic material manufactured by the manufacturing method described above.

With this, there is increased magnetic permeability and reduced coercive force of the P/M soft magnetic material, and the desired magnetic properties are achieved.

In the method for manufacturing a P/M soft magnetic material of the present implementation mode, the pressure molding step (Step S8) includes a step for forming a P/M soft magnetic material in which the plurality of composite magnetic particles 30 are joined together by organic substance 40.

With this, organic substance 40 is present between each of the plurality of composite magnetic particles 30. The organic substance acts as a lubricating agent during pressure molding. As a result, damage to the insulation covering is suppressed during pressure molding.

In the method for manufacturing a P/M soft magnetic material of the present implementation mode, there is a further third heat treatment step (Step S9) in which after the pressure molding step (Step S8), the P/M soft magnetic material is heat treated to a temperature greater than 30 degrees C. and less than the heat decomposition temperature of insulation covering 20.

With this method, distortions generated during the pressure molding step (Step S8) is reduced. Because the distortions present in the interior of metal magnetic particles are reduced in the first heat treatment step (Step S3), the distortions present in the P/M soft magnetic material are primarily generated by pressurization during pressure molding. Therefore, the distortions present in the interior of the P/M soft magnetic material are present without being complexly entangled with each other. For these reasons, even with a relatively low temperature of less than the heat decomposition temperature of insulation covering 20, for example with a phosphate type insulation covering this is 500 degrees C. or less, distortions in the interior of the molded body are effectively reduced. In addition, because the temperature of heat treatment is less than the heat decomposition temperature of insulation covering 20, insulation covering 20 surrounding the metal magnetic particles does not deteriorate. As a result, the eddy current loss generated between composite magnetic particles 30 is effectively suppressed. In addition, an adequate effect is achieved in the third heat treatment step (S9) by having a heat treatment temperature of 30 degrees C. or greater.

In the manufacturing method described above, spacer particles were separated (Step S4) immediately after the first heat treatment step (Step S3). However, as long as the separation of spacer particles (Step S4) is conducted after the first heat treatment step, it may be conducted immediately after the second heat treatment step (Step S5), for example.

(Implementation Mode 2)

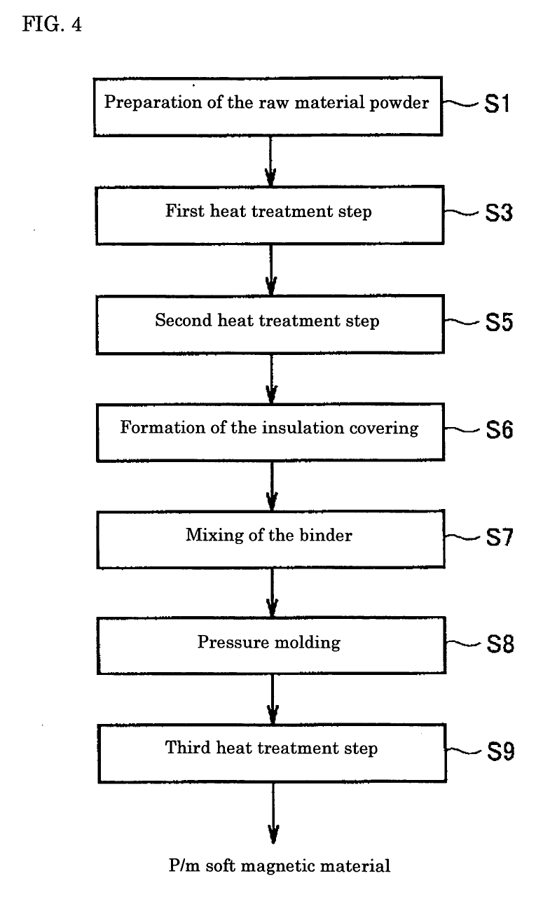

FIG. 4 is a process diagram showing a manufacturing method for a P/M soft magnetic material for Implementation mode 2 of the present invention.

Referring to FIG. 4, in the present implementation, the heat treatment method in the first heat treatment step (Step S3) is different from that of Implementation mode 1.

After preparing metal magnetic particle 10 (Step S1), metal magnetic particle 10 is heat treated (first heat treatment step, Step S3) without conducting a step for mixing with spacer particles (Step S2). This heat treatment is at a temperature of 900 degrees C. or greater and less than the melting point of the metal magnetic particle 10 and is conducted for 1 hour in a hydrogen atmosphere or argon atmosphere. This heat treatment is preferably conducted at a temperature that is 50 degrees C. or more lower than the melting point of metal magnetic particles 10. If metal magnetic particles 10 are of pure iron, the heat treatment is preferably conducted at 1450 degrees C. or less.

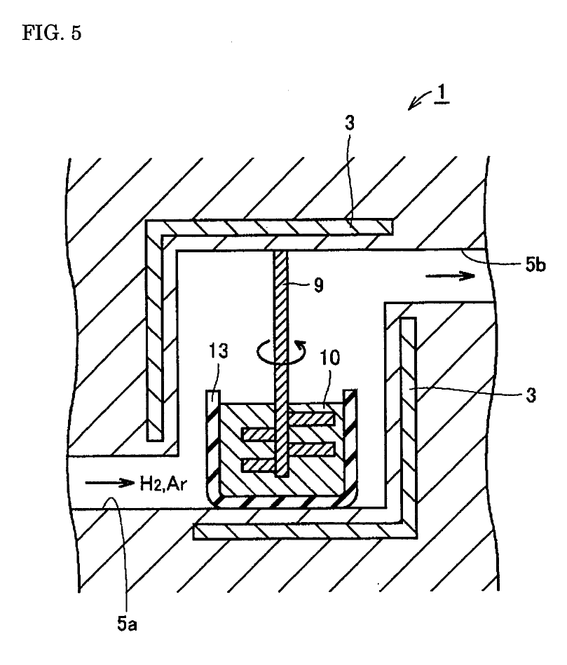

FIG. 5 is a cross-section showing the first heat treatment step of Implementation mode 2 of the present invention. Referring to FIG. 5, a container 13 filled with only metal magnetic particles 10 is placed inside an electric furnace 1 (rotating furnace), which has an internal heater 3. A stirrer 9 is inserted inside container 13. By the rotation of stirrer 9, the metal magnetic particles 10 inside container 13 are stirred. In this manner, first heat treatment step (Step S3) is conducted while moving metal magnetic particles 10. By stirring metal magnetic particles 10, continuous contact between the same metal magnetic particles during the first heat treatment step (Step S3) is prevented. As a result, even when heating to 900 degrees C. or greater, metal magnetic particles 10 do not readily become sintered. There is a gas inlet opening 5a and a gas exhaust opening 5b formed on electric furnace 1. For example, H₂ (hydrogen) gas or Ar (argon) gas or the like flows from gas inlet opening 5a to gas exhaust opening 5b.

Next, the second heat treatment step (Step S5) is conducted. For the rest of the manufacturing method of the P/M soft magnetic material, the method is approximately the same as Implementation mode 1 shown in FIG. 2, and thus the description will be omitted.

In the manufacturing method for the soft magnetic material of the present implementation mode, the first heat treatment step (Step S3) is preferably conducted while moving metal magnetic particles 10.

This prevents the same metal magnetic particles 10 from being in continuous contact with each other during the first heat treatment step (Step S3). As a result, the sintering and clumping of metal magnetic particles 10 is prevented. Therefore, there is no need for mechanically breaking up clumped metal magnetic particles after the first heat treatment step. When metal magnetic particles are mechanically broken up, new distortions can arise in the interior of the metal magnetic particles, and this problem is avoided with the present implementation mode.

The manufacturing method for the soft magnetic material and the soft magnetic material of the present invention are used to manufacture products such as P/M soft magnetic material, choke coils, switching power supply elements, magnetic heads, various motor components, automobile solenoids, various magnetic sensors, and various electromagnetic valves, and the like.

The embodiments of the present invention are described below.

(Embodiment 1)

In the present embodiments, the P/M soft magnetic material is created in accordance with the manufacturing method of FIG. 1 described in the Implementation mode 1. The effect of conducting the first heat treatment step and the effect of mixing spacer particles 7 were studied. Stated more concretely, samples A1-A6, samples B1-B6, and sample Z were each created according to the following manufacturing methods, and their coercive forces, hysteresis loss, and iron loss were measured.

(Samples A1-A6):

For metal magnetic particles 10, atomized pure iron powder (product name ABC100.30) produced by Hoganas was prepared, and metal magnetic particles 10 of particle size 75 micrometers to 250 micrometers were separated. Next, 500 g of metal magnetic particles 10 and 400 g of spacer particles 7 were mixed. For spacer particle 7, ZrO₂ of particle size 200 micrometers was used. Next, under differing temperature conditions ranging from 950 degrees C. to 1450 degrees C., the first heat treatment step of metal magnetic particles 10 was conducted. The first heat treatment step was conducted under a hydrogen atmosphere for 1 hour. Next, using a magnet, metal magnetic particles 10 and spacer particles 7 were separated. Afterwards, the coercive force of the powder of the resulting soft magnetic material was measured (coercive force after first heat treatment step). Next, a second heat treatment step was conducted on metal magnetic particles 10. The second heat treatment step was conducted for 1 hour under a hydrogen atmosphere at a temperature of 850 degrees C. Next, by chemical conversion treatment (phosphate treatment), a phosphate covering as insulation covering 20 is formed surrounding metal magnetic particle 10, and composite magnetic particle 30 is produced. The coercive force of the powder of the resulting soft magnetic material is measured (coercive force after second heat treatment step). Next, a plurality of composite magnetic particles 30 and 0.2% by volume of PPS (polyphenylene sulfide) resin are mixed in a V-type mixer for 1 hour. Next, this was compressed and molded at a pressure of 13 t/cm² (1275 MPa), and a ring-shaped P/M soft magnetic material was produced. Next, under differing temperature conditions ranging from 350 degrees C. to 500 degrees C., the third heat treatment step of metal magnetic particles 10 was conducted. The third heat treatment step was conducted for 1 hour under a nitrogen atmosphere. Afterwards, a coil was wound around the P/M soft magnetic material, and the hysteresis loss and iron loss were measured. The measurement of hysteresis loss and iron loss was conducted under conditions of an excitation magnetic flux density of 1T and a frequency of 50-1000 Hz.

(Samples B1-B6):

The first heat treatment step was conducted without mixing spacer particles 7. Otherwise, the manufacturing method was the same as the manufacturing method for samples A1-A6, and its description is omitted.

(Sample Z):

Spacer particles 7 were not mixed, and the first heat treatment step was not conducted. Otherwise, the manufacturing method was the same as the manufacturing method for samples A1-A6, and its description is omitted.

The results for the coercive force after the first heat treatment step, coercive force after the second heat treatment step, hysteresis loss, and iron loss for the resulting samples A1-A6, samples B1-B6, and sample Z are shown in Table 1.

TABLE 1

| | | Temperature | Coercive force | Coercive force | | | | | | | | |
|---|---|---|---|---|---|---|---|---|---|---|---|---|
| | | during first | (A/m) after | (A/m) after | Hysteresis loss [W/kg] | | | | Iron loss [W/kg] | | | |
| | | heat | first heat | second heat | Temperature during third heat | | | | Temperature during third heat | | | |
| | | treatment | treatment | treatment | treatment step | | | | treatment step | | | |
| | | step | step | step | 350° C. | 400° C. | 450° C. | 500° C. | 350° C. | 400° C. | 450° C. | 500° C. |
| Sample Z | | — | — | 179 | 109 | 94 | 81 | 69 | 141 | 129 | 118 | 106 |
| Insulation | Sample A1 | 950° C. | 180 | 160 | 104 | 89 | 74 | 61 | 135 | 124 | 110 | 100 |
| particles | Sample A2 | 1050° C. | 160 | 147 | 98 | 84 | 69 | 53 | 130 | 121 | 107 | 95 |
| present | Sample A3 | 1150° C. | 146 | 130 | 89 | 76 | 61 | 48 | 122 | 111 | 99 | 87 |
| | Sample A4 | 1250° C. | 141 | 123 | 85 | 71 | 57 | 45 | 116 | 106 | 95 | 86 |
| | Sample A5 | 1350° C. | 122 | 111 | 81 | 67 | 53 | 43 | 112 | 102 | 90 | 84 |
| | Sample A6 | 1450° C. | 107 | 86 | 77 | 63 | 49 | 36 | 107 | 99 | 88 | 77 |
| No | Sample B1 | 950° C. | 213(Crushing | 174 | 105 | 91 | 77 | 66 | 138 | 124 | 114 | 108 |
| insulation | | | necessary) | | | | | | | | | |
| particles | Sample B2 | 1050° C. | 226(Crushing | 189 | 122 | 96 | 73 | 65 | 159 | 134 | 112 | 107 |
| | | | necessary) | | | | | | | | | |
| | Sample B3 | 1150° C. | 232(Crushing | 193 | 119 | 94 | 77 | 72 | 154 | 127 | 115 | 114 |
| | | | necessary) | | | | | | | | | |
| | Sample B4 | 1250° C. | 259(Crushing | 212 | 146 | 120 | 97 | 83 | 177 | 155 | 135 | 125 |
| | | | necessary) | | | | | | | | | |

| | | | | | | | | | | |
|---|---|---|---|---|---|---|---|---|---|---|
| Sample B5 | 1350° C. | After first annealing, crushing | — | — | — | — | — | — | — | — |
| | | not possible | | | | | | | | |
| Sample B6 | 1450° C. | After first annealing, crushing | — | — | — | — | — | — | — | — |
| | | not possible | | | | | | | | |

As shown in Table 1, with samples B1-B6 in which spacer particles were not mixed, the metal magnetic particles became sintered and clumped to each other in the first heat treatment step, and crushing was necessary. In particular, with samples B5 and B6, the metal magnetic particles were sintered and so clumped together that crushing could not be conducted. As a result, the coercive force after first heat treatment step, the coercive force after the second heat treatment step, hysteresis loss, and iron loss could not be measured. In contrast, with samples A1-A6 in which spacer particles 7 were mixed, there was hardly any sintering and clumping of metal magnetic particles 10. From this, it can be seen that by mixing spacer particles 7, sintering and clumping together of metal magnetic particles 10 is suppressed.

In addition, for each of the samples A1-A6 in which the first heat treatment step was conducted, the coercive force after the first heat treatment, coercive force after the second heat treatment, hysteresis loss, and iron loss were all lower than those of sample Z in which the first heat treatment step was not conducted. From this, it can be seen that by conducting the first heat treatment step, the desired magnetic properties is achieved.

(Embodiment 2)

In the present embodiment, the P/M soft magnetic material of FIG. 1 was created according to the manufacturing method described in Implementation mode 2. The effect of conducting the first heat treatment step and the effect of conducting the first heat treatment step while stirring metal magnetic particles 10 were studied. Stated more concretely, samples C1-C6, samples B1-B6, and sample Z were each produced according to the following manufacturing method. The coercive force, hysteresis loss, and iron loss were measured.

(Samples C1-C6):

The first heat treatment step was conducted without mixing spacer particles. As shown in FIG. 5, the first heat treatment step was conducted while stirring metal magnetic particles 10. Otherwise, the manufacturing method was the same as the manufacturing method for samples A1-A6, and its description is omitted.

(Samples B1-B6):

The first heat treatment step was conducted without stirring metal magnetic particles 10. Otherwise, the manufacturing method was the same as the manufacturing method for samples A1-A6, and its description is omitted.

(Sample Z):

Spacer particles 7 were not mixed, and the first heat treatment step was not conducted. Otherwise, the manufacturing method was the same as the manufacturing method for samples A1-A6, and its description is omitted.

The results for the coercive force after the first heat treatment step, coercive force after the second heat treatment step, hysteresis loss, and iron loss for the resulting samples C1-C6, samples B1-B6, and sample Z are shown in Table 2.

TABLE 2

| | | Temperature | Coercive force | Coercive force | | | | | | | | |
|---|---|---|---|---|---|---|---|---|---|---|---|---|
| | | during first | (A/m) after | (A/m) after | Hysteresis loss [W/kg] | | | | Iron loss [W/kg] | | | |
| | | heat | first heat | second heat | Temperature during third heat | | | | Temperature during third heat | | | |
| | | treatment | treatment | treatment | treatment step | | | | treatment step | | | |
| | | step | step | step | 350° C. | 400° C. | 450° C. | 500° C. | 350° C. | 400° C. | 450° C. | 500° C. |
| Sample Z | | — | — | 179 | 109 | 94 | 81 | 69 | 141 | 129 | 118 | 106 |
| Stirred | Sample C1 | 950° C. | 163 | 150 | 89 | 75 | 68 | 61 | 122 | 105 | 98 | 90 |
| | Sample C2 | 1050° C. | 142 | 120 | 79 | 69 | 64 | 53 | 110 | 99 | 93 | 82 |
| | Sample C3 | 1150° C. | 123 | 110 | 66 | 62 | 58 | 46 | 95 | 90 | 88 | 78 |
| | Sample C4 | 1250° C. | 111 | 99 | 59 | 53 | 47 | 42 | 88 | 83 | 76 | 74 |
| | Sample C5 | 1350° C. | 99 | 82 | 57 | 53 | 45 | 39 | 86 | 82 | 75 | 70 |
| | Sample C6 | 1450° C. | 86 | 70 | 57 | 50 | 41 | 33 | 89 | 81 | 72 | 66 |
| Not | Sample B1 | 950° C. | 213(Crushing | 174 | 105 | 91 | 77 | 66 | 138 | 124 | 114 | 108 |
| strirred | | | necessary) | | | | | | | | | |
| | Sample B2 | 1050° C. | 226(Crushing | 189 | 122 | 96 | 73 | 65 | 159 | 134 | 112 | 107 |
| | | | necessary) | | | | | | | | | |
| | Sample B3 | 1150° C. | 232(Crushing | 193 | 119 | 94 | 77 | 72 | 154 | 127 | 115 | 114 |
| | | | necessary) | | | | | | | | | |
| | Sample B4 | 1250° C. | 259(Crushing | 212 | 146 | 120 | 97 | 83 | 177 | 155 | 135 | 125 |
| | | | necessary) | | | | | | | | | |

| | | | | | | | | | | |
|---|---|---|---|---|---|---|---|---|---|---|
| Sample B5 | 1350° C. | After first annealing, crushing | — | — | — | — | — | — | — | — |
| | | not possible | | | | | | | | |
| Sample B6 | 1450° C. | After first annealing, crushing | — | — | — | — | — | — | — | — |
| | | not possible | | | | | | | | |

As shown in Table 2, with samples C1-C6 in which the first heat treatment step was conducted while stirring metal magnetic particles 10, there was very little sintering and clumping together of metal magnetic particles 10. From this, it can be seen that by conducting the first heat treatment step while stirring metal magnetic particles 10, sintering and clumping of metal magnetic particles 10 is prevented.

In addition, for each of the samples C1-C6 in which the first heat treatment step was conducted, the coercive force after the first heat treatment, coercive force after the second heat treatment, hysteresis loss, and iron loss were all lower than those of sample Z in which the first heat treatment step was not conducted. From this, it can be seen that by conducting the first heat treatment step, the desired magnetic properties is achieved.

The implementations and embodiments of the present invention disclosed are only examples, and they are not limited to these. The scope of the present invention is not limited to the above description, but it is indicated in the claims and includes any modifications within the scope of the claims.

1. A method for manufacturing a soft magnetic material, comprising:
a first heat treatment step in which metal magnetic particles which have iron as a main component are heated to a temperature of 900 degrees C. or greater and less than the melting point of said metal magnetic particles;
after said first heat treatment step, a step for forming a plurality of composite magnetic particles in which said metal magnetic particles are surrounded by an insulation covering.

2. A method for manufacturing a soft magnetic material as described in claim 1, wherein:
after said first heat treatment step, there is a second heat treatment step in which said metal magnetic particles are heated to a temperature of 400 degrees C. or greater and less than 900 degrees C.;
said step for forming said plurality of composite magnetic particles is conducted after said second heat treatment step.

3. A method for manufacturing a soft magnetic material as described in claim 1, wherein:
prior to said first heat treatment step, there is a step in which said metal magnetic particles is mixed with spacer particles.

4. A method for manufacturing a soft magnetic material as described in claim 3, wherein:
a ratio (D2/D1) of an average particle diameter D1 of said metal magnetic particles to an average particle diameter D2 of said spacer particles is 0.1≦(D2/D1)≦2.

5. A method for manufacturing a soft magnetic material as described in claim 3, wherein:
said spacer particle is an oxide, nitride, or carbide of at least one element selected from the group consisting of Al, Si, Y, Zr, Ti, Mg, and B.

6. A method for manufacturing a soft magnetic material as described in claim 1, wherein:
said first heat treatment step is conducted while said metal magnetic particles are in motion.

7. A soft magnetic material manufactured by a manufacturing method described in claim 1.

8. A method for manufacturing a powder-metallurgy (P/M) soft magnetic material, comprising:
a pressure molding step in which said soft magnetic material manufactured by a method described in claim 1 is pressure molded.

9. A method for manufacturing a P/M soft magnetic material as described in claim 8, wherein:
said pressure molding step includes a step for formation of said P/M soft magnetic material in which said plurality of composite magnetic particles are joined with each other by an organic substance.

10. A method for manufacturing a P/M soft magnetic material as described in claim 8, wherein:
after said pressure molding step, there is a third heat treatment step in which heat treatment is conducted at a temperature between 30 degrees C. and the heat decomposition temperature of said insulation covering.

11. A P/M soft magnetic material manufactured by a method described in claim 8.
